(19) United States
(12) Patent Application Publication
(10) Pub. No.: US 2026/0267331 A1
(43) Pub. Date: Sep. 10, 2026

(54) LATENCY DETERMINATION FOR A TELEOPERATED VEHICLE

(71) Applicant: Toyota Motor Engineering & Manufacturing North America, Inc., Plano, TX (US)

(72) Inventors: Xunbi Ji, Ann Arbor, MI (US); Sergei S. Avedisov, Redwood City, CA (US); Mohammad Irfan Khan, Sunnyvale, CA (US); Onur Altintas, Sunnyvale, CA (US); Taishi Sase, Santa Clara, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/071,125

(22) Filed: Mar. 5, 2025

(51) Int. Cl. G05D 1/226; G05D 109/10; G05D 111/30

(52) U.S. Cl. CPC G05D 1/226; G05D 2109/10; G05D 2111/32

(57) ABSTRACT

Systems, methods, and other embodiments described herein relate to determining latency for a teleoperated vehicle. In one embodiment, a method includes determining latency for a teleoperated vehicle based on at least operator response latency related to driving characteristics of an operator, control latency, and communication latency. The method further includes outputting the latency to an output system.

### TECHNICAL FIELD

The subject matter described herein relates, in general, to systems and methods for determining latency for a teleoperated vehicle.

### BACKGROUND

In the teleoperated driving, latency presents a significant challenge. Latency may occur during the transmission of the information via a wireless network, within the perception and control unit in the remote teleoperation center, and in the actuation of the mechanical systems in the teleoperated vehicle. As such, the overall latency in a teleoperated driving system can significantly deteriorate the teleoperated driving performance and may lead to safety critical situations during the teleoperated driving maneuver.

### SUMMARY

In one embodiment, a method for determining latency for a teleoperated vehicle is disclosed. The method includes determining latency for a teleoperated vehicle determining latency for a teleoperated vehicle based on at least operator response latency related to driving characteristics of an operator, control latency, and communication latency. The method further includes outputting the latency to an output system.

In another embodiment, a system for determining latency for a teleoperated vehicle is disclosed. The system includes a processor and a memory in communication with the processor. The memory stores machine-readable instructions that, when executed by the one processor, cause the processor to determine latency for a teleoperated vehicle based on at least operator response latency related to driving characteristics of an operator, control latency, and communication latency, and output the latency to an output system.

In another embodiment, a non-transitory computer-readable medium for determining latency for a teleoperated vehicle is disclosed. The instructions include instructions to determine latency for a teleoperated vehicle based on at least operator response latency related to driving characteristics of an operator, control latency, and communication latency, and output the latency to an output system.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an example of a teleoperated driving system incorporating a teleoperated vehicle latency determination system.

FIG. 2 illustrates one embodiment of the teleoperated vehicle latency determination system.

FIG. 3 is a flowchart illustrating one embodiment of a method associated with determining latency for a teleoperated vehicle.

FIGS. 4A-4B are flowcharts illustrating one embodiment of a process flow for latency calibration.

FIGS. 5A-5C are an example of a teleoperated vehicle latency determination scenario.

### DETAILED DESCRIPTION

Systems, methods, and other embodiments associated with determining latency for a teleoperated vehicle are disclosed. A teleoperated vehicle is a vehicle that is controlled remotely by an operator located in a control center or a teleoperation center. The operator may be a human operator, an automated operator, or a combination of a human operator and an automated operator. Latency is when the operator issues a control command and when the teleoperated vehicle receives the control, acts on the control command, and/or transmits a response to the operator may present several challenges to the operator. As an example, the operator is receiving information about the teleoperated vehicle such as the location coordinates of the teleoperated vehicle. However, if the teleoperated vehicle is in motion and there is a delay in when the information was sent by the teleoperated vehicle and when the information was received by the operator, the location coordinates may be obsolete as the teleoperated vehicle may have moved from that location in the time it took for the information to travel from the teleoperated vehicle to the operator.

Another challenge that the operator may consider is the difference in time between when the operator sends a control command and when the teleoperated vehicle receives and acts on the control command. As such, the operator may utilize the latency values to predict the position or location coordinates of the teleoperated vehicle as well as the appropriate control command at the predicted location coordinates.

Latency in teleoperated driving may be difficult to measure. As an example, control latency such as the actuation latency of the mechanical systems in the teleoperated vehicle may be difficult to measure. As another example, the reaction time of the operator (human or automated) may be difficult to measure directly as the measurement of the operator response latency depends on the operator and the individual teleoperated vehicle. Overall latency is useful to the operator as the overall latency may be used in multiple strategies for mitigating the effect of latencies.

Accordingly, in one embodiment, the disclosed approach is a system and a method for determining latency for a teleoperated vehicle based on the operator response latency, the control latency, and/or the communication latency. The method includes a calibration process. The method includes controlling the teleoperated vehicle in a predetermined space or path. The method includes adding a first timestamp to data that is being transmitted from the teleoperation center to the teleoperated vehicle, adding a second timestamp when the data is received in the teleoperated vehicle, adding a third timestamp when data is being transmitted from the teleoperated vehicle to the teleoperation center and a fourth timestamp when the data is received in the teleoperation center. The method includes determining the communication latency based on the first, second, third, and/or fourth timestamps of the data. The data may be in any suitable format including text format, audio format, and/or video format. The method also includes determining the overall latency by controlling the teleoperated vehicle in the predetermined space and recording the trajectory, which may include the location coordinates, the speed of travel, the acceleration rate, and/or the orientation of the teleoperated vehicle.

The method further includes determining the constant latency which is based on the operator response latency and the control latency. The method may include determining the constant latency based on the difference between the overall latency and the communication latency. The communication latency may vary based on the communication network being used for data transmission.

The embodiments disclosed herein present various advantages over conventional technologies for teleoperated driving. First, the embodiments are able to estimate end-to-end latencies with a short calibration process. Second, the embodiments can assist the operator in operating various teleoperated vehicles, which may have different latencies. Third, the embodiments include the operator response latency in the overall latency, which makes the overall latency more accurate. Fourth, the embodiments can be used for multiple operators as the operator response latency may be recalculated for different operators. Fifth, the embodiments continually adjust the communication latency in real-time, aiding in maintaining the accuracy of the overall latency. Sixth, the embodiments control the teleoperated vehicle based on the continually varying communication latency in real-time.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

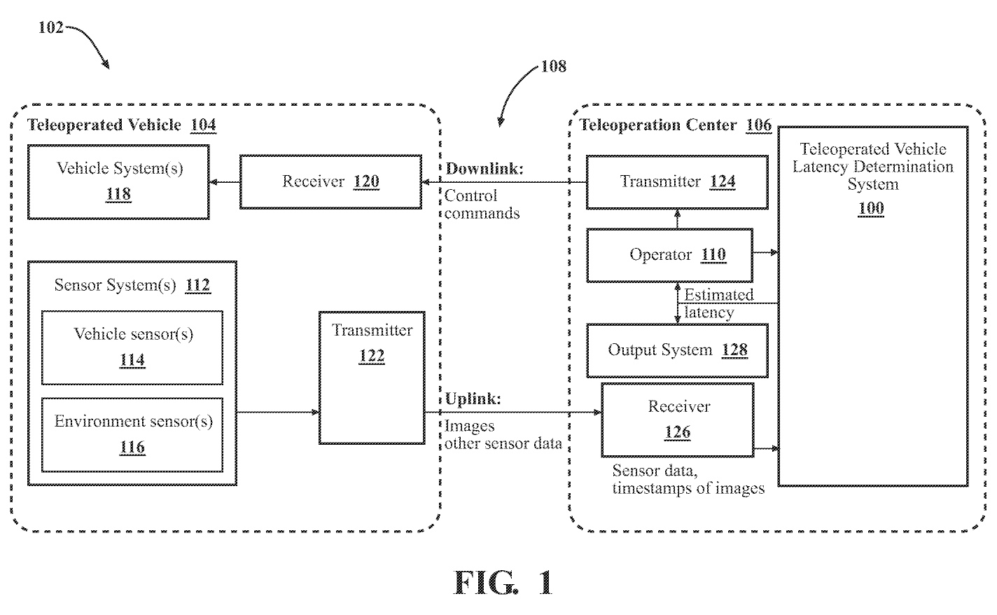

Referring to FIG. 1, an example of a teleoperated driving system 102 incorporating a teleoperated vehicle latency determination system 100 is illustrated. The teleoperated driving system 102 may include various elements, which may be communicatively linked in any suitable form. As an example, the elements may be connected, as shown in FIG. 1. Some of the possible elements of the teleoperated driving system 102 such as a teleoperated vehicle 104 and a teleoperation center 106 are shown in FIG. 1 and will now be described. It will be understood that it is not necessary for the teleoperated driving system 102 to have all the elements shown in FIG. 1 or described herein. The teleoperated driving system 102 may have any combination of the various elements shown in FIG. 1. Further, the teleoperated driving system 102 may have additional elements to those shown in FIG. 1. In some arrangements, the teleoperated driving system 102 may not include one or more of the elements shown in FIG. 1. Further, it will be understood that one or more of these elements may be physically separated by large distances.

The elements of the teleoperated driving system 102 may be communicatively linked through one or more communication networks 108. As used herein, the term “communicatively linked” can include direct or indirect connections through a communication channel or pathway or another component or system. A “communication network” means one or more components designed to transmit and/or receive information from one source to another. The one or more of the elements of the teleoperated driving system 102 may include and/or execute suitable communication software, which enables the various elements to communicate with each other through the communication network 108 and perform the functions disclosed herein.

The one or more communication networks 108 can be implemented as, or include, without limitation, a wide area network (WAN), a local area network (LAN), the Public Switched Telephone Network (PSTN), a wireless network, a mobile network, a Virtual Private Network (VPN), the Internet, and/or one or more intranets. The communication network 108 further can be implemented as or include one or more wireless networks, whether short-range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long-range (e.g., a mobile, cellular, and/or satellite-based wireless network; GSM, TDMA, CDMA, WCDMA networks or the like). The communication network 108 can include wired communication links and/or wireless communication links. The communication network 108 can include any combination of the above networks and/or other types of networks.

The teleoperated driving system 102 can include one or more teleoperated vehicles 104. A teleoperated vehicle 104 is a vehicle that is remotely controlled by an operator 110 from a stationary control station such as the teleoperation center 106. As used herein, “vehicle” means any form of motorized transport. In one or more implementations, the teleoperated vehicle 104 can be an automobile. While arrangements will be described herein with respect to automobiles, it will be understood that embodiments are not limited to automobiles. In some implementations, the teleoperated vehicle 104 may be any device that, for example, transports passengers and/or objects. The teleoperated vehicle 104 can be any other type of vehicle that may be used on a roadway, such as a motorcycle. In some implementation, the teleoperated vehicle 104 can be a watercraft, an aircraft, or any other form of motorized transport.

The teleoperated vehicle 104 may include various elements. The teleoperated vehicle 104 may include a sensor system 112. The sensor system 112 may include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 112 includes a plurality of sensors, the sensors can work independently from each other. Alternatively, two or more of the sensors can work in combination with each other. In such a case, the two or more sensors can form a sensor network. The sensor system 112 can include any suitable type of sensor. Various examples of different types of sensors will be described herein. However, it will be understood that the embodiments are not limited to the particular sensors described. The sensor system 112 can include one or more vehicle sensors 114. The vehicle sensor(s) 114 can detect, determine, and/or sense information about the teleoperated vehicle 104 itself. In one or more arrangements, the vehicle sensor(s) 114 can be configured to detect, and/or sense position and orientation changes of the teleoperated vehicle 104, such as, for example, based on inertial acceleration. In one or more arrangements, the vehicle sensor(s) 114 can include one or more accelerometers, one or more gyroscopes, an inertial measurement unit (IMU), a dead-reckoning system, a global navigation satellite system (GNSS), a global positioning system (GPS), a navigation system, and/or other suitable sensors. In one or more arrangements, the vehicle sensor(s) 114 can include a speedometer to determine a current speed of the teleoperated vehicle 104. The vehicle sensor(s) 114 can be configured to detect, and/or sense one or more characteristics of the vehicle.

Alternatively, or in addition, the sensor system 112 can include one or more environment sensors 116 configured to acquire, and/or sense driving environment data. “Driving environment data” includes data or information about the external environment in which the vehicle is located or one or more portions thereof. For example, the one or more environment sensors 116 can be configured to detect, quantify and/or sense obstacles in at least a portion of the external environment of the teleoperated vehicle 104 and/or information/data about such obstacles. Such obstacles may be stationary objects and/or dynamic objects. The one or more environment sensors 116 can be configured to detect, measure, quantify and/or sense other objects in the external environment of the teleoperated vehicle 104, such as, for example, roadways, lane markers, signs, traffic lights, traffic signs, lane lines, crosswalks, curbs, off-road objects, electronic roadside devices, etc. The one or more environment sensors 116 can be configured to detect, measure, quantify and/or sense precipitation, temperature, light levels, etc.

Various examples of sensors of the sensor system 112 will be described herein. The example sensors may be part of the one or more environment sensors 116 and/or the one or more vehicle sensors 114. However, it will be understood that the embodiments are not limited to the particular sensors described.

As an example, in one or more arrangements, the sensor system 112 can include one or more radar sensors, one or more LIDAR sensors, one or more sonar sensors, and/or one or more cameras. In one or more arrangements, the one or more cameras can be high dynamic range (HDR) cameras or infrared (IR) cameras.

The teleoperated vehicle 104 can include one or more vehicle systems 118. Various examples of the one or more vehicle systems 118 are disclosed. However, the teleoperated vehicle 104 can include more, fewer, or different vehicle systems 118. It should be appreciated that although particular vehicle systems are separately defined, each or any of the systems or portions thereof may be otherwise combined or segregated via hardware and/or software within the teleoperated vehicle 104. The teleoperated vehicle 104 can include a propulsion system, a braking system, a steering system, throttle system, a transmission system, a signaling system, and/or a navigation system. Each of these systems can include one or more devices, components, and/or a combination thereof, now known or later developed. The teleoperated vehicle 104 may further include one or more vehicle system controllers for controlling the vehicle systems 118.

The teleoperated vehicle 104 can include a receiver 120 and a transmitter 122. The receiver 120 is configured to receive control commands from the teleoperation center 106 and transmit the control commands to the vehicle system controller(s), the vehicle system(s) 118, the sensor system(s) 112, and/or other elements within the teleoperated vehicle 104. The transmitter 122 is configured to transmit information such as sensor data and any other relevant vehicle information to the teleoperation center 106.

The teleoperated driving system 102 can include one or more teleoperation centers 106. As previously mentioned, the teleoperation center 106 is a control station from which the operator 110 controls the teleoperated vehicle 104. As an example, the operator 110 may be a human operator. As another example, the operator 110 may be an automated operator. Further and as another example, the teleoperated vehicle 104 may be remoted controlled by a combination of a human operator and an automated operator.

The teleoperation center 106 can include various elements. As an example and as illustrated, the teleoperation center 106 can include a transmitter 124, a receiver 126, and the teleoperated vehicle latency determination system 100. The transmitter 124 in the teleoperation center 106 is configured to receive control commands from the operator 110 and/or the operator interface (not shown) and transmit the control commands to the receiver 120 in the teleoperated vehicle 104. The receiver 126 in the teleoperation center 106 is configured to receive information, such as sensor data, images, etc., from the transmitter 122 in the teleoperated vehicle 104.

The teleoperation center 106 includes the teleoperated vehicle latency determination system 100. The teleoperated vehicle latency determination system 100 is capable of determining the latency. The teleoperated vehicle latency determination system 100 may determine an operator response latency related to driving characteristics of an operator 110, control latency, and communication latency. The teleoperated vehicle latency determination system 100 may determine the overall latency of the teleoperated vehicle 104 based on a difference between a prescribed target trajectory and the actual trajectory of the teleoperated vehicle 104. The teleoperated vehicle latency determination system 100 may also determine the overall latency by summing up the operator response latency, the control latency, and/or the communication latency, in a case where the operator response latency, the control latency, and/or the communication latency were determined in advance and/or monitored in real time. The teleoperated vehicle latency determination system 100 is described in more detail below.

In a case where the operator 110 is automated, the teleoperation center 106 can include an automated operator 110 capable of transmitting control commands to the teleoperated vehicle 104. In a case where the operator is a human, the teleoperation center 106 can include an operator interface configured to receive control commands from the human operator and transmit the control commands to the teleoperated vehicle 104. The teleoperated vehicle latency determination system 100 may output the latency to the automated operator 110 and/or the operator interface. Upon receiving the latency from the teleoperated vehicle latency determination system 100, the automated operator 110 may then output control commands based on the latency. In the case where the operator is human and upon receiving the latency from the teleoperated vehicle latency determination system, the operator interface may determine and output (e.g., display) recommended control commands, driving speeds and maneuvers based on the latency.

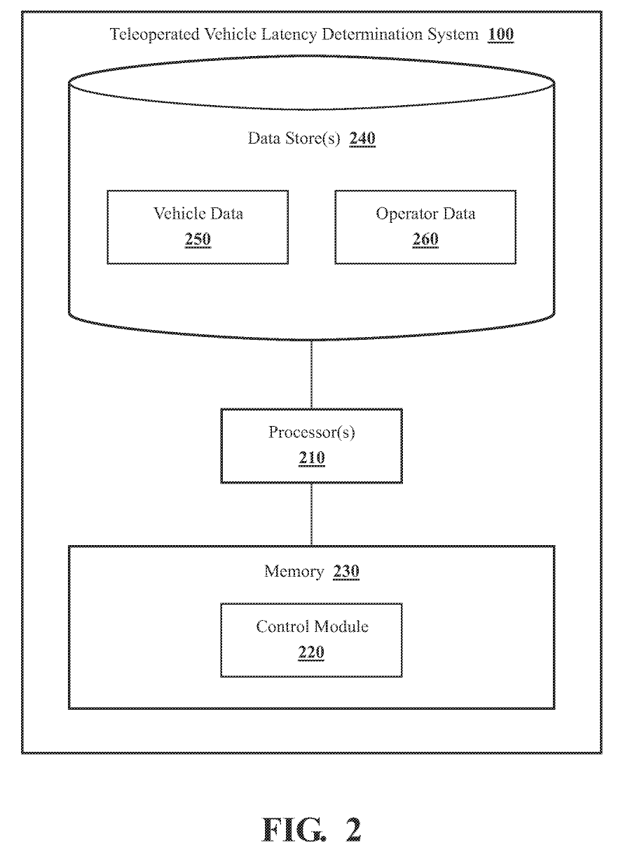

With reference to FIG. 2, one embodiment of the teleoperated vehicle latency determination system of FIG. 1 is further illustrated. The teleoperated vehicle latency determination system 100 can include one or more processors 210. “Processor” means any component or group of components that are configured to execute any of the processes described herein or any form of instructions to carry out such processes or cause such processes to be performed. The processor(s) 210 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 210 can include at least one hardware circuit (e.g., an integrated circuit) configured to carry out instructions contained in program code. In arrangements in which there is a plurality of processors 210, such processors can work independently from each other or one or more processors can work in combination with each other.

In one embodiment, the teleoperated vehicle latency determination system 100 includes a memory 230 that stores a control module 220. The memory 230 is a random-access memory (RAM), read-only memory (ROM), a hard-disk drive, a flash memory, or other suitable memory for storing the control module 220. The control module 220 is, for example, computer-readable instructions within the physical memory 230 that when executed by the processor 210 cause the processor 210 to perform the various functions disclosed herein.

In one embodiment, the teleoperated vehicle latency determination system 100 includes a data store 240. The data store 240 is, in one embodiment, an electronic data structure (e.g., a database) stored in the memory 230 or another data store and that is configured with routines that can be executed by the processor 210 for analyzing stored data, providing stored data, organizing stored data, and so on. Thus, in one embodiment, the data store 240 stores data used by the control module 220 in executing various functions. In one embodiment, the data store 240 includes vehicle data 250, operator data 260, and or other information that is used by the control module 220. The vehicle data 250 may contain information about the teleoperated vehicle 104 such as the type of teleoperated vehicle 104, the location of the teleoperated vehicle 104, and the orientation and/or speed of travel of the teleoperated vehicle 104. The operator data 260 may contain information about the operator 110 controlling the teleoperated vehicle 104 such as an operator identifier, profile, driving style, and/or response time.

In one embodiment, the control module 220 includes instructions that function to control the processor 210 to determine latency for a teleoperated vehicle 104 based on at least operator response latency related to driving characteristics of an operator 110, control latency, and communication latency. As previously mentioned, the operator 110 may be a human operator, an automated operator, or a combination of a human and automated operator. The driving characteristics of the operator 110 may include a driving style of the operator 110, control style of the operator 110, response time of the operator 110, or temperament of the operator 110. The driving style of the operator 110 refers to how the operator 110 controls the teleoperated vehicle 104 such as driving speed, the speed and angle with which the operator 110 takes turns, an acceleration rate, and/or a deceleration rate when braking. The control style of the operator 110 may refer to an overall style of the operator 110 when controlling the teleoperated vehicle 104, including operator preferences such as cabin temperature, preferred routes for travel, etc. The response time of the operator 110 refers to the amount of time it takes for the operator 110 to respond to an event. The temperament of the operator 110 refers to the demeanor of the operator 110 in response to an event. As an example, the temperament of the operator 110 may include whether the operator 110 remains calm or becomes anxious in response to certain events such as an emergency. The control module 220 may request information relating to the characteristics and/or more specifically, the driving characteristics of the operator 110. As an example, the control module 220 may request information from the operator 110 and receive relevant responses from the operator 110. For a human operator, the control module 220 may request and receive information via a user interface such as an input keypad and a display screen. The teleoperation center 106 may include sensors monitoring the human operator and outputting sensor data. The control module 220 may access the sensor data from the sensors and may then determine or predict the characteristics of the human operator based on the sensor data. The control module 220 may utilize any historical information, suitable machine learning processes, and/or artificial intelligence methods to determine the driving characteristics of the operator 110 based on at least the sensor data.

The control module 220 may then determine the operator response latency based on the driving characteristics of an operator 110. The operator response latency refers to the time delay between when the operator 110 receives information and when the operator 110 acts on the information. The control module 220 may utilize the driving characteristics or more generally, the characteristics of the operator 110 to determine the operator response latency. The control module 220 may identify patterns in the characteristics of the operator 110 based on historical information and past behavior, and may apply any suitable algorithms, machine learning processes, and/or artificial intelligence methods to determine the operator response latency based on the characteristics and/or driving characteristics of the operator 110.

The control module 220 may determine the control latency. The control latency refers to the time delay between when a vehicle system 118 such as the propulsion system, the braking system, the steering system, the throttle system, the transmission system, the signaling system, and/or a navigation system receives a control command and when the vehicle system 118 acts on the control command. The control command may include time stamps. The teleoperated vehicle 104 may track the time the control command is received at the receiver 120, the time the control command is transmitted from the receiver 120 to the related vehicle system, the time the related vehicle system 118 receives the control command, and the time that the vehicle system 118 acts on and carries out the control command. The teleoperated vehicle 104 may store the times mentioned above and, in response to a request from the control module 220, the teleoperated vehicle 104 may transmit the times and the associated vehicle system 118 to the control module 220.

The control module 220 may determine the latency based on one of a single axis, two axes, or three axes. In other words, the control module 220 may determine the latency based on one, two, or three axes of motion. As an example, the control module 220 may determine the latency based on one or more of the longitudinal axis, the lateral axis, and the vertical axis of the teleoperated vehicle 104. In an example of the latency being based on a single axis such as the longitudinal axis, the control module 220 may monitor the latency relating to the propulsion system, the throttle system, and the braking system as these vehicle systems 118 facilitate forward and backward movement of the teleoperated vehicle 104. In an example of the latency being based on two axes such as the longitudinal axis and the lateral axis, the control module 220 may monitor the latency relating to the propulsion system, the throttle system, and the braking system as these vehicle systems 118 facilitate forward and backward movement of the teleoperated vehicle 104 and the steering system as the steering system facilitates sideways movement of the teleoperated vehicle 104. In an example of the latency being based on three axes such as the longitudinal axis, the lateral axis, and the vertical axis, the control module 220 may monitor the latency relating to the propulsion system, the throttle system, and the braking system as these vehicle systems 118 facilitate forward and backward movement of the teleoperated vehicle 104, the steering system as the steering system facilitates sideways movement of the teleoperated vehicle 104, a propulsion system such as is utilized in an aircraft as the propulsion system facilitates vertical movement.

The control module 220 may determine the communication latency. The communication latency refers to the time delay between when a control command is sent from the teleoperation center 106 and when the control command is received at the teleoperated vehicle 104. The communication latency also refers to the time delay between when information is sent from the teleoperated vehicle 104 and when the information is received at the teleoperation center 106. Communication between the teleoperated vehicle 104 and the teleoperation center 106 can be referred to as uplink and downlink. Uplink communication is communication from the teleoperated vehicle 104 to the teleoperation center 106 and downlink communication is communication from the teleoperation center 106 to the teleoperated vehicle 104. As an example, the control module 220 may transmit a test or sample data to the teleoperated vehicle 104, requesting that the test data be transmitted back upon receipt. The control module 220 may determine the communication latency by measuring the difference between when the test data was transmitted and when the test data was received back.

The control module 220 may then determine the latency of the teleoperated vehicle 104 based on the operator response latency, the control latency, and/or the communication latency. As an example, the control module 220 may determine the latency as a sum of one or more of the operator response latency, the control latency, and the communication latency. The control module 220 may further generate a vehicle model such as a kinematic bicycle model based on the latency. The control module 220 may utilize the vehicle model for predicting future latency values.

The control module 220 may determine the latency based on at least a trajectory or orientation of the teleoperated vehicle 104 along a predetermined path. As an example, the predetermined path may be a track with sensors placed along the track such that the sensors are capable of capturing the teleoperated vehicle 104 at any location on the track. The operator 110 in the teleoperation center 106 may transmit command controls to the teleoperated vehicle 104 and may monitor the sensor data from the sensors to determine the latency between when the control commands were transmitted and when the control commands were carried out within the teleoperated vehicle 104.

In one embodiment, the control module 220 includes instructions that function to control the processor 210 to output the latency to an output system 128. The output system 128 may be a display system such as a display screen and/or an audio system such as a speaker. As an example, the display system may be located in the teleoperation center 106 and/or a mobile device. As another example, the audio system may be located in the teleoperation center 106 and/or the mobile device. The output system 128 may be at any other suitable location such as in a cloud server. The output system 128 may be a display system visible to the operator 110 and/or an audio system audible to the operator 110. As such and as an example, the control module 220 may output the estimated latency to a user interface, a display screen, a database, a server, and/or a third-party server.

In one embodiment, the control module 220 includes instructions that function to control the processor 210 to control the teleoperated vehicle 104 based on the latency. Upon determining the latency, the control module 220 may determine the origin of the teleoperated vehicle 104 and the destination of the teleoperated vehicle 104. As an example, the control module 220 may transmit a location request to the teleoperated vehicle 104 and may receive the location of the teleoperated vehicle 104. As another example, using a user interface, the control module 220 may receive the desired destination of the teleoperated vehicle 104. Using the estimated latency and any suitable vehicle systems 118, the control module 220 may transmit control commands based on the estimated latency to the teleoperated vehicle 104 and to the suitable vehicle systems 118 such as the navigation system, the steering system, and/or the throttle system. The control module 220 may predict the location of the teleoperated vehicle 104 based on the sensor data and the latency, and may then determine and transmit the next control commands to the teleoperated vehicle 104.

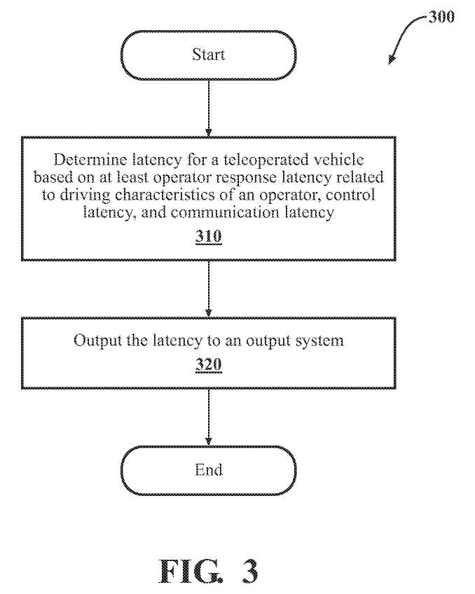

FIG. 3 is a flowchart illustrating one embodiment of a method 300 associated with determining latency for a teleoperated vehicle 104. The method 300 will be described from the viewpoint of the teleoperated vehicle latency determination system of FIG. 1 and the teleoperated vehicle latency determination system of FIG. 2. However, the method 300 may be adapted to be executed in any one of several different situations and not necessarily by the teleoperated vehicle latency determination system of FIG. 1 and the teleoperated vehicle latency determination system of FIG. 2.

At step 310, the control module 220 may cause the processor(s) 210 to determine latency for a teleoperated vehicle 104 based on at least operator response latency related to driving characteristics of an operator 110, control latency, and communication latency. As previously mentioned, the operator 110 may be one or both of a human operator and an automated operator. The control module 220 may determine a response latency for the operator 110 based on the driving characteristics of the operator 110. The control module 220 may determine the characteristics and/or driving characteristic of the operator 110 based on input information received from the operator 110, sensor data, and/or historical information. As previously mentioned, the driving characteristics may include one or more of the driving style of the operator 110, the control style of the operator 110, the response time of the operator 110, or temperament of the operator 110. The control module 220 may then utilize any suitable algorithm, machine learning techniques, and/or artificial intelligence methods to determine the operator response latency.

The control module 220 may then determine control latency, which may be based on the vehicle system 118 being controlled. The control module 220 issue a control command to the vehicle system 118 and measure the time taken for the vehicle system 118 to act or operate in response to the control command. In other words, the control module 220 may issue a control command for the teleoperated vehicle 104 to brake and may then measure the time taken for the teleoperated vehicle 104 to brake in response to the control command. The control module 220 may determine communication latency by measuring the time taken for data transmitted from the teleoperation center 106 to the teleoperated vehicle 104 to return to the teleoperation center 106. As an example, the control module 220 may further determine whether a distance between the teleoperation center 106 and the teleoperated vehicle 104 impacts the communication latency. As another example, the control module 220 may determine whether the varying functionality of the communication network 108 impacts the communication latency.

The control module 220 may determine the latency based on one of a single axis, two axes, or three axes, as disclosed above. Also discussed above, the control module 220 may generate a vehicle model such as a kinematic bicycle model of the teleoperated vehicle based on the latency. The control module 220 may further determine the latency based on at least a trajectory or orientation of the teleoperated vehicle 104 along a predetermined path. In such a case, the control module 220 may record the latency between when the operator 110 issues a control command and when the vehicle system 118 in the teleoperated vehicle 104 executes an action based on the control command. The control command may record one or more of the latency, the operator response latency, the control latency, and the communication latency and the control module 220 may determine the latency based on one or more of the recorded latency, the operator response latency, the control latency, and the communication latency.

At step 320, the control module 220 may cause the processor(s) 210 to outputting the latency to an output system 128. The control module 220 may output the latency to the operator 110, a database, a server, and/or any interested third party. The control module 220 may also control the teleoperated vehicle 104 based on the latency.

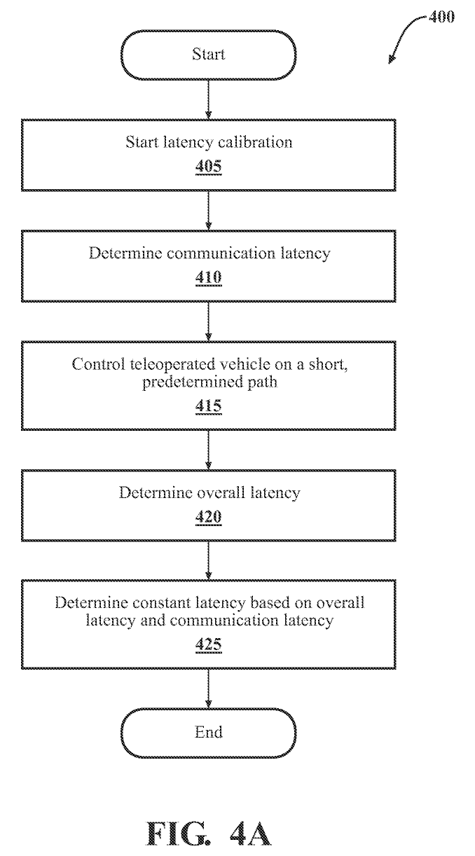

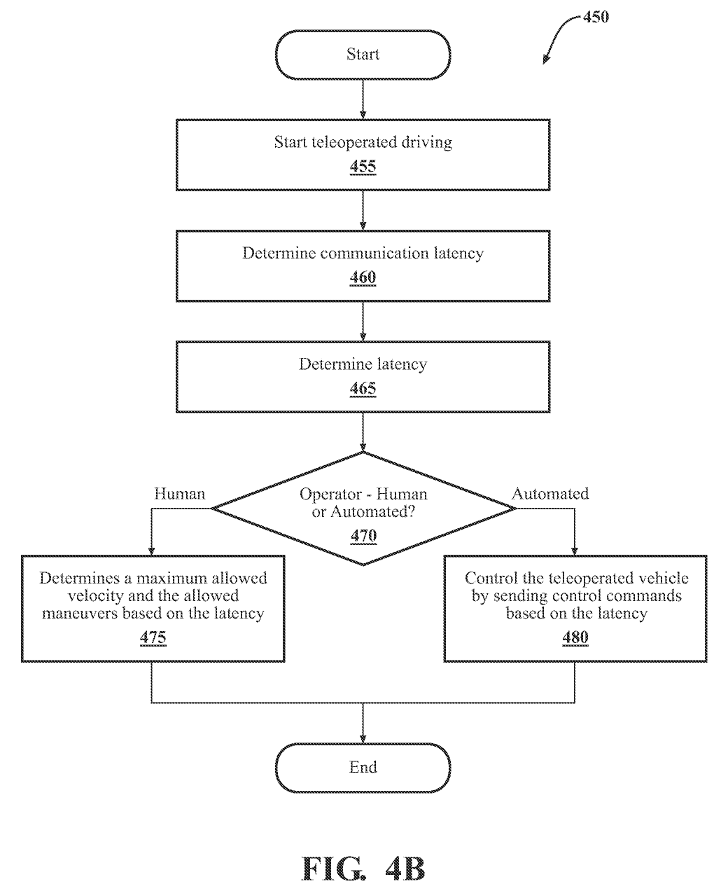

FIG. 4A is a flowchart illustrating one embodiment of a process flow 400 for latency calibration. More specifically, the flowchart illustrates a method for determining a constant latency which is overall latency less the communication latency. In other words, the constant latency does not vary based on the location of the teleoperated vehicle 104 or the communication network 108 being utilized. The process flow 400 will be described from the viewpoint of the teleoperated vehicle latency determination system 100 of FIG. 1 and the teleoperated vehicle latency determination system 100 of FIG. 2. However, the process flow 400 may be adapted to be executed in any one of several different situations and not necessarily by the teleoperated vehicle latency determination system 100 of FIG. 1 and the teleoperated vehicle latency determination system 100 of FIG. 2.

At step 405, the control module 220 may cause the processor(s) 210 to start latency calibration by controlling the teleoperated vehicle 104 to drive on a short, predetermined path. As such, the control module 220 sends a message to the operator 110 to control the teleoperated vehicle 104.

At step 410, and in response to the message, the operator 110 may initially transmit data from the teleoperation center 106 to the teleoperated vehicle 104 and measure the time taken for the transmitted data to return. The control module 220 may receive and store the measured time taken. The control module 220 may determine the communication latency based on the measured time taken for the data to be transmitted and then return.

At step 415, and in response to the message, the operator 110 sends control commands to the teleoperated vehicle 104 and records the trajectory of the teleoperated vehicle 104 such as location coordinates, speed of travel, acceleration rate, and/or orientation of the teleoperated vehicle 104.

At step 420, the control module 220 determines the latency (also known as overall latency) based on the time when the operator 110 sends the control commands and the time that the teleoperated vehicle 104 acts in response to the control commands.

At step 425, the control module 220 determines a constant latency, which is the latency less the communication latency. The constant latency includes at least the operator response latency and the control latency.

FIG. 4B is a flowchart illustrating one embodiment of a process flow 450 for latency calibration. The process flow 450 will be described from the viewpoint of the teleoperated vehicle latency determination system 100 of FIG. 1 and the teleoperated vehicle latency determination system 100 of FIG. 2. However, the process flow 400 may be adapted to be executed in any one of several different situations and not necessarily by the teleoperated vehicle latency determination system 100 of FIG. 1 and the teleoperated vehicle latency determination system 100 of FIG. 2.

At step 455, the control module 220 may cause the processor(s) 210 to start teleoperated driving with the teleoperated vehicle 104. As such, the control module 220 sends a message to the operator 110 to control the teleoperated vehicle 104.

At step 460, and in response to the message, the operator 110 may initially transmit data from the teleoperation center 106 to the teleoperated vehicle 104 and measure the time taken for the transmitted data to return. The control module 220 may receive and store the measured time taken. The control module 220 may determine the communication latency for the teleoperated driving based on the measured time taken for the data to be transmitted and then return.

At step 465, the control module 220 determines the latency based on the constant latency and the communication latency for the teleoperated driving. As an example, the control module 220 may determine the latency based on a sum of the constant latency and the communication latency. The communication latency may vary depending on the communication network. As such, the control module 220 may continually determine the communication latency in real-time and utilize the communication latency while controlling the teleoperated vehicle 104 in real-time.

At step 470, the control module 220 determines whether the operator 110 is human or automated. If the operator 110 is automated, the next step is step 475 and if the operator 110 is human, the next step is step 480.

At step 475, the control module 220 determines a maximum allowed velocity and the allowed maneuvers based on the latency. As an example, the control module 220 may determine the maximum allowed velocity and allowed maneuvers based on historical information, any suitable algorithm (e.g., based on a relationship between latency values, velocity values and driving maneuvers), machine learning techniques, and/or artificial intelligence processes. The control module 220 may then output the maximum allowed velocity and the allowed maneuvers to the operator 110. The control module 220 may output to, as an example, a display screen or an audio speaker. Further, the control module 220 may monitor the teleoperation by the operator 110 and may intervene when the latency value reaches or exceeds a predetermined threshold value. As an example, the intervention may include outputting a warning, via the display screen or the audio speaker, to the operator 110. As another example, the intervention may include switching control from a human operator to an automated operator.

At step 480, the control module 220 causes the operator 110 to control the teleoperated vehicle 104 by sending control commands based on the latency.

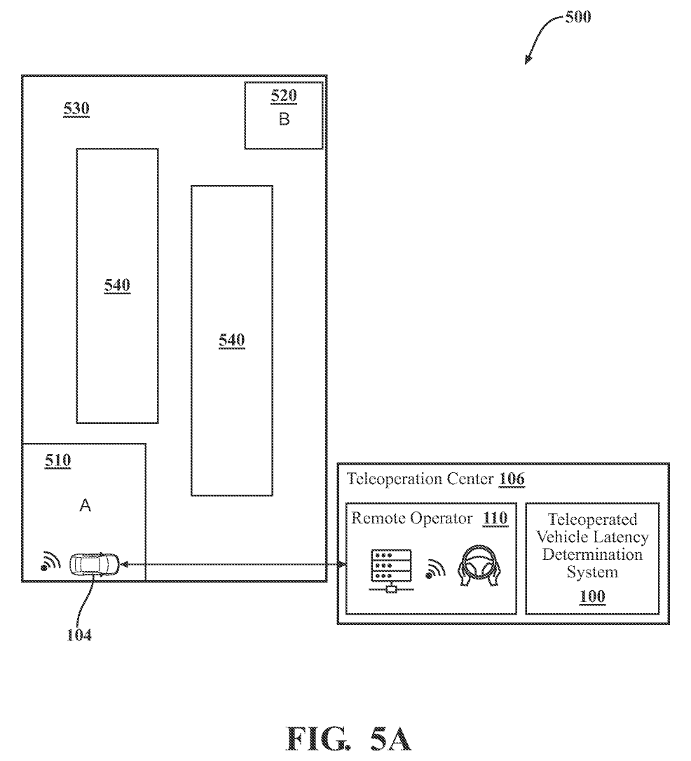

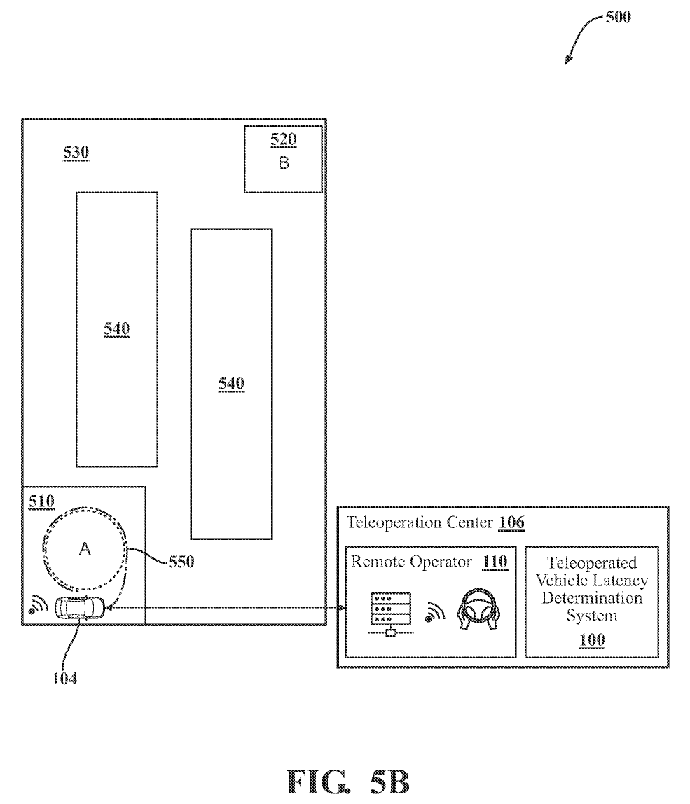

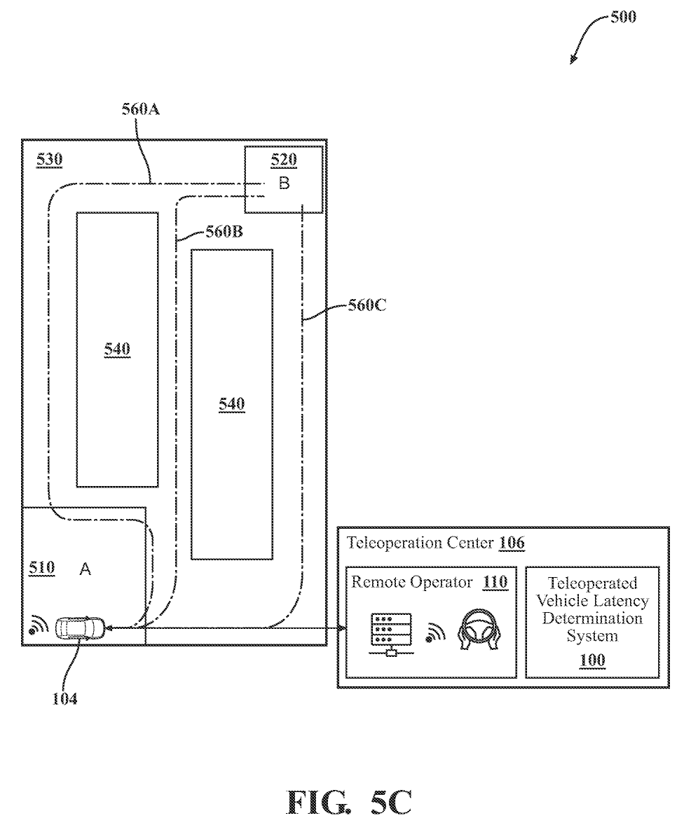

FIGS. 5A-5C are an example of a teleoperated vehicle latency determination scenario 500, where a teleoperated vehicle 104 is to be driven from zone A 510 to zone B 520 along the clear zones 530 and avoiding the obstacle zones 540.

In FIG. 5A, the teleoperated vehicle 104 is located in zone A and is communicatively linked to the operator 110. As such, the operator 110 is capable of controlling the teleoperated vehicle 104.

In FIG. 5B, the teleoperated vehicle latency determination system 100 and more specifically, the control module 220 determines the communication latency of the teleoperated vehicle 104. The teleoperated vehicle latency determination system 100 and more specifically, the control module 220 sends a message to the operator 110 to control the teleoperated vehicle 104 within the zone A. As shown and as an example, the operator 110 may control the teleoperated vehicle 104 such that the teleoperated vehicle travels in a circle 550 within the zone A. The control module 220 may record the time taken for data to be sent to the teleoperated vehicle 104 and then to be returned. The control module 220 may determine the communication latency based on the time taken. The communication latency may include two portions – the time for data to be transmitted from the teleoperation center 106 to the teleoperated vehicle 104 and the time for data to be transmitted from the teleoperated vehicle 104 to the teleoperation center 106.

The control module 220 may also determine the overall latency which is the time difference between when the operator 110 sends a control command and when the teleoperated vehicle 104 acts in response to the control command. As the teleoperated vehicle 104 travels within zone A 510, the control module 220 may then determine the constant latency based on the difference between the overall latency and the communication latency. The communication latency may vary based on the communication network 108 and/or on the distance between the teleoperated vehicle 104 and the teleoperation center 106. As such, the communication latency may vary with distance, time, and/or communication network functionality. However, the constant latency is based on the control latency and the operator response latency. The constant latency does not vary with distance and/or time and is more likely to remain constant throughout the teleoperated drive.

In FIG. 5C, the control module 220 determines the overall latency based on the constant latency and a communication latency. The control module 220 may continually measure and update the communication latency as the teleoperated vehicle travels from zone A 510 to zone B 520. The operator 110 may select a path 560A, 560B, 560C from the clear zones 530, avoid the obstacle zones 540, and send control commands to the teleoperated vehicle 104, controlling the teleoperated vehicle 104 to travel from zone A 510 to zone B 520, based on the overall latency, safety, and efficiency.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer, or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of … and ….” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
determining latency for a teleoperated vehicle based on at least operator response latency related to driving characteristics of an operator, control latency, and communication latency; and
outputting the latency to an output system.

2. The method of claim 1, further comprising:
controlling the teleoperated vehicle based on the latency.

3. The method of claim 1, wherein the operator is one of:
a human operator; or
an automated operator.

4. The method of claim 1, wherein the driving characteristics of the operator include:
driving style of the operator;
control style of the operator;
response time of the operator; or
temperament of the operator.

5. The method of claim 1, further comprising:
determining the latency based on one of:
a single axis;
two axes; or
three axes.

6. The method of claim 1, further comprising:
generating a vehicle model of the teleoperated vehicle based on the latency.

7. The method of claim 1, further comprising:
determining the latency based on at least a trajectory or orientation of the teleoperated vehicle along a predetermined path.

8. A system comprising:
a processor; and
a memory storing machine-readable instructions that, when executed by the processor, cause the processor to:
determine latency for a teleoperated vehicle based on at least operator response latency related to driving characteristics of an operator, control latency, and communication latency; and
output the latency to an output system.

9. The system of claim 8, wherein the machine-readable instructions further include instructions that when executed by the processor cause the processor to:
control the teleoperated vehicle based on the latency.

10. The system of claim 8, wherein the operator is one of:
a human operator; or
an automated operator.

11. The system of claim 8, wherein the driving characteristics of the operator include:
driving style of the operator;
control style of the operator;
response time of the operator; or
temperament of the operator.

12. The system of claim 8, wherein the machine-readable instructions further include instructions that when executed by the processor cause the processor to:
determine the latency based on one of:
a single axis;
two axes; or
three axes.

13. The system of claim 8, wherein the machine-readable instructions further include instructions that when executed by the processor cause the processor to:
generate a vehicle model of the teleoperated vehicle based on the latency.

14. The system of claim 8 wherein the machine-readable instructions further include instructions that when executed by the processor cause the processor to:
determine the latency based on at least a trajectory or orientation of the teleoperated vehicle along a predetermined path.

15. A non-transitory computer-readable medium including instructions that, when executed by a processor, cause the processor to:
determine latency for a teleoperated vehicle based on at least operator response latency related to driving characteristics of an operator, control latency, and communication latency; and
output the latency to an output system.

16. The non-transitory computer-readable medium of claim 15, wherein the instructions further include instructions that when executed by the processor cause the processor to:
control the teleoperated vehicle based on the latency.

17. The non-transitory computer-readable medium of claim 15, wherein the operator is one of:
a human operator; or
an automated operator.

18. The non-transitory computer-readable medium of claim 15, wherein the driving characteristics of the operator include:
driving style of the operator;
control style of the operator;
response time of the operator; or
temperament of the operator.

19. The non-transitory computer-readable medium of claim 15, wherein the instructions further include instructions that when executed by the processor cause the processor to:
determine the latency based on one of:
a single axis;
two axes; or
three axes.

20. The non-transitory computer-readable medium of claim 15, wherein the instructions further include instructions that when executed by the processor cause the processor to:
generate a vehicle model of the teleoperated vehicle based on the latency.
